(19) United States
(12) Patent Application Publication
(10) Pub. No.: US 2015/0059139 A1
(43) Pub. Date: Mar. 5, 2015

(54) TOOL FOR SEMIAUTOMATIC APPLICATION AND REMOVAL OF MULTIPLE TEMPORARY FASTENERS

(71) Applicant: Rafael Francisco Furlan Dantas, Jacarei / SP (BR)

(72) Inventor: Rafael Francisco Furlan Dantas, Jacarei / SP (BR)

(21) Appl. No.: 14/379,224

(22) PCT Filed: Feb. 7, 2013
(86) PCT No.: PCT/BR2013/000042

§ 371 Date: Aug. 15, 2014

(30) Foreign Application Priority Data
Feb. 17, 2012 (BR) 10 2012 003669 0

(51) Int. Cl. B25B 31/00

(52) U.S. Cl. CPC B25B 31/005
USPC 29/252

(57) ABSTRACT

Tool for semiautomatic application and removal of multiple temporary fasteners, consists essentially of a pneumatic tool (1), semi-automated, used to apply and remove temporary fasteners (2) placed in a feeding clip (3), with a retention system, in a cavity (4) in the front, and aligned with the clip (5) of the cylinder (6) activated by compressed air in the direction of pushing the fixation element against a (7) reaction base and from there to the pieces (P) t be drilled and riveted, while also having a collection container (8) when removing the temporary fasteners (2) using the same tool.

This Patent of Invention request relates to an innovative tool for semiautomatic application and removal of multiple temporary fasteners. It is a pneumatic tool equipped with a frontal cavity for receiving a feeding clip that holds a given number of temporary fasteners, where they remain locked thanks to a retention system sprung when a pneumatic cylinder trigger is activated that displaces the clip in the direction of pushing the temporary fastener in the direction of a reaction base, and from there to the pieces to be worked, and the same tool is used to remove and collect them in a container installed in front of the tool.

The application field for the invention is the aerospace industry, preferably for the fastening of external panels of aircraft where it drilling and riveting is necessary.

In the aerospace segment it is common to search for equipment and materials that improve and/or make processes more practical, safer and offer greater quality, whether in the manufacturing or in the maintenance of aircraft.

In the development and manufacturing of an air or space vehicle, processes are used that involve a compromise between capacities, operation time, performance, technology available and cost.

In the manufacturing and assembly of aircraft parts it is not always possible to access both sides of the parts, so that when it is necessary to make several holes/rivets in a multiple layered structure, it is necessary to use temporary fasteners that can be connected and accessed only on one side of the surface.

In order to have perfect drilling in a panel and/or fuselage, it must be done in several steps in which the diameters of the holes are gradually and successively increased. In this sense, with each hole drilled, a temporary fastener is introduced, which ha a clip system accompanied by a spring for both closing and opening.

Therefore, the temporary fasteners function so as not to permit the separation of structural members of the plates during the drilling and other operations and which later, once riveted, these temporary fasteners may be removed for final and permanent fastening.

The nomenclature used for these devices is Cleco®, the focus of this patent deposit, which, as already mentioned, has a clip system with a spring for closing when fastening several plates and opening at the end of the job.

At present, the temporary fasteners can be places in totally manual way or by using a pneumatic tool. In the first, a device is used that functions similar to a pliers, in which the operator positions the fastener between two “heads” which when pressed provide sufficient force to press the spring and close the clip thus permitting its introduction into the hole, whereas without this pressure, it loosens the spring and permits removing the tool.

On the other hand, the pneumatic tool operates in similar fashion, with the difference being that it has a cylinder that makes the pressure on the spring when activated with a trigger device.

In both modalities, the temporary fasteners are applied one by one, making the job excessively long.

Also, observe that this tool dies not serve to remove the temporary fasteners, where pliers are needed for such.

The current state of the technique anticipates some patent documents that speak about the matter in question, such as MU 8400826-1 “Arrangement applied in a positioner and a temporary clamper of plate”. Comprised of a clip pin, attached to a hollowed out retention element, a cylindrical body from which a threaded and a smooth part project, presenting at the extremity a resilient clip, a butterfly nut, a cylindrical support rod and at the extremity a spherical support used for the retention and the alignment of panels.

The above device, although allegedly simple, functions manually, that is, it demands great physical effort by the operator, occupying more space when compared to other temporary fasteners available on the market.

Document US2002/0144574 presents a pneumatic tool equipped with a grooved ferrule that moves in the direction of the wedge-shaped temporary fastener that includes four skewed elastic clips that pass through the hole encompassing 360° of its perimeter. By increasing the surface and contact, it reduces the possibility of deformation of structural members.

The above product applies the fasteners one by one, which increase the task time and compromises productivity. Furthermore, the grooved ferrule used to push the fastener element is of complex manufacturing and difficult to fit with the fastener when placing it. This difficulty in fit is greater for the removal of the fastener, where is necessary for the operator to turn the hand that holds the tool to do so, thus causing an additional repetitive movement. If the fit is not done correctly, the fasteners hexagon head will be damaged.

In short, the current state of the technique presents the following main disadvantages:
The introduction of the temporary fastener, in the pliers as well as in the conventional tool, causes a loss in productivity due to delays in carrying out the operation;
Use of the pliers for placing the temporary fasteners is slow and it requires the operator to be firm to avoid dropping the fastener from the pliers, while it is not positioned;
This manual operation cause injuries (RMD) to the operator due to the need for the operator to make continuous efforts to overcome the fasteners spring;
The movement of the tips of the pliers is a circular movement, thus the effort to overcome the spring is inclined in relation to the axis of the temporary fastener, thus compromising its useful life;
When removing the temporary fastener, the operator needs to hold it with the pliers using his free hand until the effort on the same is sufficient to remove it.

With the purpose of solving the aforementioned problems, and to present an economically feasible solution for production, the inventor, a professional linked to the sector in question, idealized the tool for semiautomatic application and removal of multiple temporary fasteners, which along general lines can be defined as a pneumatic tool equipped with a cylinder with a guide clip, which when activated using the trigger abuts the multiply positioned and juxtaposed temporary fasteners in a clip with a semiautomatic advance, where they remain locked through a retention system until contact with the referred to clip, which pushes it to the reaction base and from there to the pieces to be drilled and riveted. This same tool is capable of removing the temporary fasteners from the pieces by simply removing the clip and placing a collection container along the reaction baseline.

Conceptually, this inventions uses the construction of a pneumatic tool; however, upon equipping it with a feeding clip with the temporary fasteners inserted and locked in their positions to be used systematically, provides much greater productivity than the conventional method, plus the fact that it permits the removal operation, also in a quick manner, and the subsequent reuse of the temporary fasteners.

In short, the invention deposited herein has the following major advantages:
Since cylinder activation is a linear movement, the useful life of the temporary fasteners increases because there is not lateral force against it when the spring is pressed, and it also avoids any loss of the fastener by falling to the ground when removed;
Less time for placing the temporary fasteners, increasing productivity;
Less operator effort thus avoiding problems related to RMD from activating the pliers for placement and removal of the fasteners;
Functionality and practicality—goes beyond the basic objective of inserting temporary fasteners, enabling a new form of semiautomatic insertion and preserving the operator from physical efforts;
Easy to use, with an excellent cost x benefit ratio.
Reduced manufacturing cost—simple construction and availability of materials in the market.

Below, the functional, aesthetic and structural particularities of the invention are explained, with reference to the attached drawings, in which they are represented in an illustrative but not limited manner:

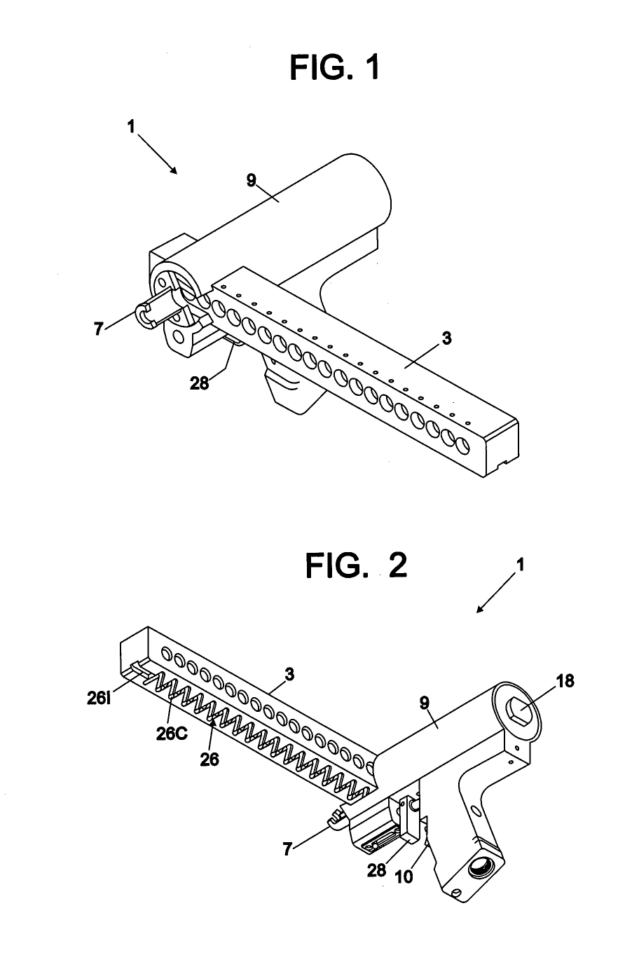

FIG. 1: Perspective view of the tool for semiautomatic application an removal of multiple temporary fasteners;

FIG. 2: Inverted perspective view of the tool for semiautomatic application an removal of multiple temporary fasteners;

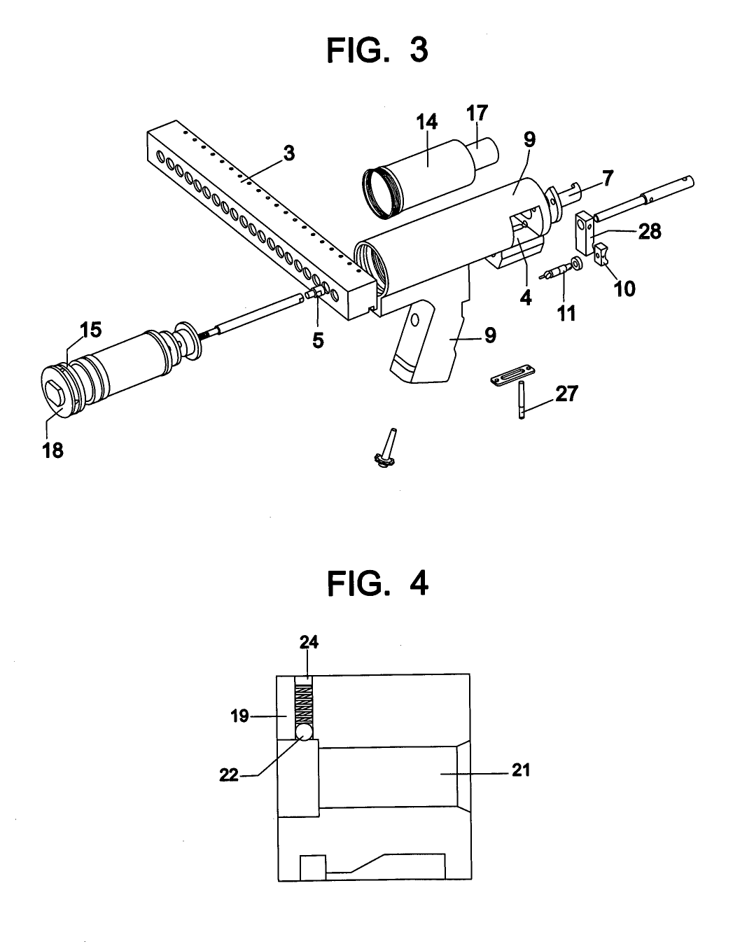

FIG. 3: Exploded perspective view of the tool for semiautomatic application an removal of multiple temporary fasteners;

FIG. 4: Side view at an angle of the tool's clip for the semiautomatic application and removal of multiple temporary fasteners, without the temporary fasteners;

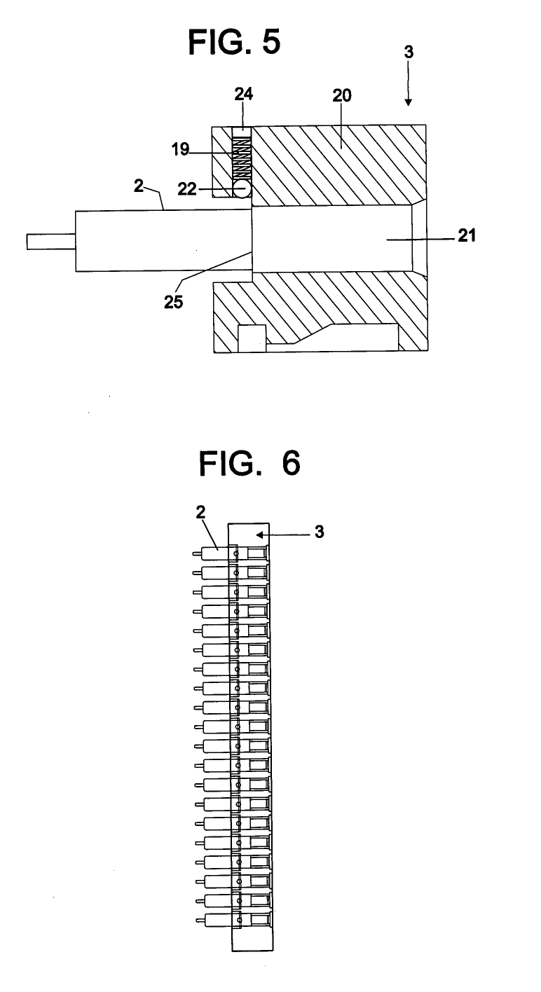

FIG. 5: Side view at an angle of the tool's clip for the semiautomatic application and removal of multiple temporary fasteners, with the temporary fasteners;

FIG. 6: Overhead view at an angle of the tool's clip for the semiautomatic application and removal of multiple temporary fasteners, with the temporary fasteners;

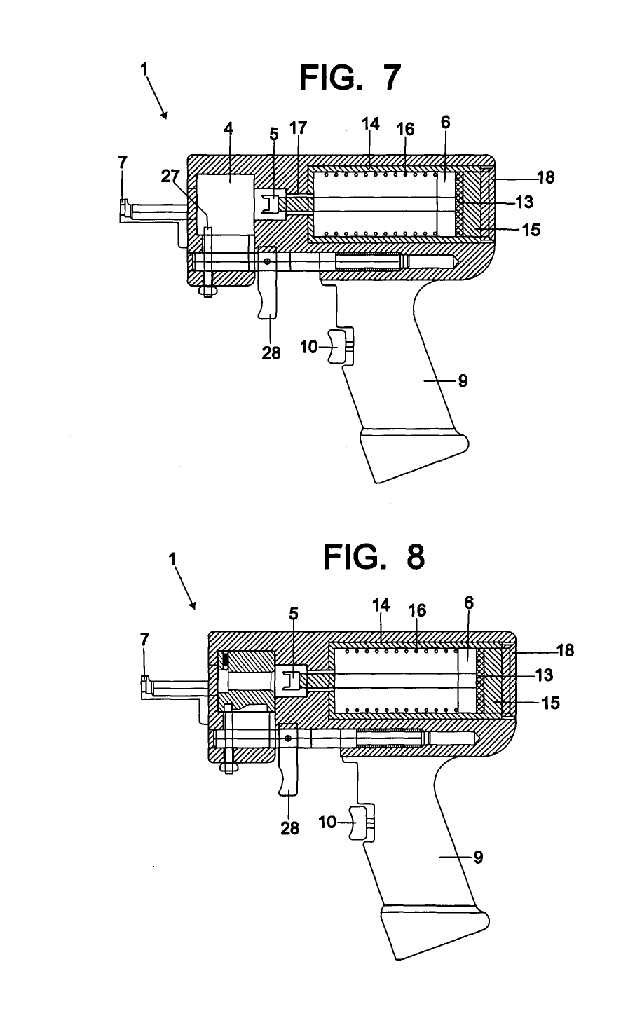

FIG. 7: Side view at an angle of the tool's clip for the semiautomatic application and removal of multiple temporary fasteners, without the clip;

FIG. 8: Side view at an angle of the tool's clip for the semiautomatic application and removal of multiple temporary fasteners, with the clip;

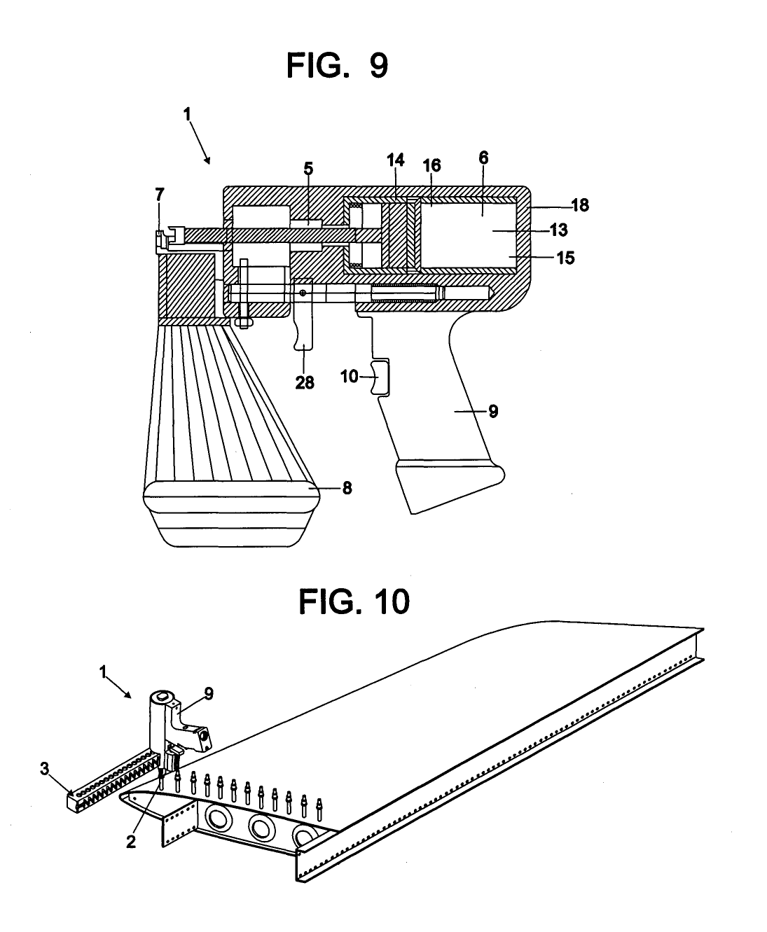

FIG. 9: Side view at an angle of the tool's clip for the semiautomatic application and removal of multiple temporary fasteners, showing the removal of the temporary fasteners;

FIG. 10: Perspective view of the tool for semiautomatic application an removal of multiple temporary fasteners, showing the use;

The tool for semiautomatic application and removal of multiple temporary fasteners, which is the object of this deposit of a Patent for Invention, essentially consists of a pneumatic tool (1), semi-automated, used to apply and remove temporary fasteners (2) placed in a feeding clip (3), with a retention system, in a cavity (4) in the front, and aligned with the clip (5) of the cylinder (6) activated by compressed air in the direction of pushing the fixation element against a (7) reaction base and from there to the pieces (P) t be drilled and riveted, while also having a collection container (8) when removing the temporary fasteners (2) using the same tool.

More specifically, the pneumatic tool (1) proposed is comprised of a housing (9), on which the trigger (10) for the advancing cylinder is positioned (6) that activates the internal valve (11) releasing the passage of compressed air to the rear (13) of the cylinder sleeve (14) and its top (15), thus pushing the cylinder shaft (6) forward and against the feeding clip (3). When the trigger is released (10) the passage of air stop and the rear part is depressurized (13), located between the sleeve (14) of the cylinder (6) and its top (15), and the cylinder shaft (6) returns to the resting position through return (16) spring action. On the other hand, the cylinder shaft (6), in the front, is guided and supported by a bushing (17). The entire cylinder assembly is fixed and locked using a closing cap (18). At the end of the cylinder shaft (6), a clip is seen (5) which performs the work of fitting into the rear of the temporary fastener (2) and conducting it to the reaction base (7) from where it is exuded after overcoming the force of the spring (19) in the feeding clip retention system (3). In more detail, the clip body (20) has a rectangular section and it is hollowed out in the center (21) compatible with the contour of the temporary fasteners (2) lodged in it, that is, in the juxtaposed spaces, where they remain locked in position due to the action of a sphere (22), pressed by a spring (190 and bolt 24) which makes contact with a salience (25) that is found in the temporary fastener itself. After completing the placement of the temporary fasteners (2), the feeding clip (3) is introduced into the frontal cavity (4) of the pneumatic tool (1) with the movement canal (26) facing down, pressing the advance pin (27) which occupies the initial section (261) of the canal, thus permitting the entry of th feeding clip (3) from the left to the right, which moves until reaching the position of the first temporary fastener (2) to be applied, where the advance pin (27) hits in the end-of-course (26C). In this condition, the pneumatic tool (1) is ready to insert the first temporary fastener (2) from the feeding clip (3) at the provisional junction of pieces (P) to be drilled and riveted. Pressing the trigger (10) of the advance cylinder and the respective clip (5), the movement begins the back and closing of the temporary fastener (2) so the operator can introduce it into the hole. Once this step is concluded, the operator releases the trigger (10) of the advance cylinder, so that it returns to its initial position through spring action (16). In order to position a new temporary fastener (2), the operator pulls the trigger back (28) from the feeding clip, thus inducing spring retraction (29) along the shaft (30) of the advance pin (27). Advance pin movement makes the movement canal (26) shift to the right, until the alignment of the next temporary fastener with the clip (5) of the advance cylinder (6), beginning a new cycle. The operator successively repeats these operations until installation of the last temporary fastener (2), releasing the trigger (10) of the advance cylinder so it returns to its initial position. At this moment, the operator presses the advance trigger half way (28) so that the feeding clip (3) is unlocked and can be removed on the right side, enabling the invention. When the insertion operation of the temporary fasteners (2) is concluded, the operator can use the same pneumatic tool (1), simply removing the feeding clip (26) and positioning a collection container (8) for the temporary fasteners (2) by simply attaching it to the reaction base (7). The removal operation is done by fitting the temporary fastener (2) in the reaction base (7) and activating the trigger (10) of the advance cylinder (6) in the sense of pressing the rear part of the temporary fastener (2) through the guide clip (5) and releasing it from the plate junction. Pulling the pneumatic tool (1) back and releasing the trigger (10) of the advance cylinder (6), makes the guide clip (5) draw back, releasing the temporary fastener (2), which, once free, falls, by gravity action, into the collection container (8).

Therefore, that is the description and illustration of the best way currently considered to present this patent for invention.

However, it must be understood that, this innovative modification is not limited to the practical aspects of the currently preferred manner, described and illustrated, and that all such modifications and variations should be considered as being encompassed within the spirit and the scope of this patent for invention.

What claimed is:

1. Tool for semiautomatic application and removal of multiple temporary fasteners, comprised of a housing (9) with activation trigger (10) by compressing an advance cylinder wherein its shaft has a clip (5) which fits to the rear part of the temporary fasteners (2) positioned and locked in multiples and hollowed out (21) on a feeding clip (3) which operates semi-automatically and positions itself in the front cavity (4) of the pneumatic tool (1) and which, when they touch the reaction base (7) are applied to the holes in the pieces; a collection container (8) attached to the reaction base (7) holds the temporary fasteners removed by the tool (1).

2. Tool for semiautomatic application and removal of multiple temporary fasteners, according to claim 1, wherein the feeding clip (3) has a rectangular and centrally hollowed out section (21) compatible with the contour of the temporary fastener (2) locked through the action of a sphere (22), pressed by a spring (19) and bolt (24), which makes contact with a salience (25) on the fastener.

3. Tool for semiautomatic application and removal of multiple temporary fasteners, according to claims 1 and 2, wherein the feeding clip (3) is moved by the trigger (28) which moves the advance pin (27) in contact with the movement canal (26) that shifts perfectly until aligning with the clip (5) of the advance cylinder (6) the shaft of which is supported in the bushing (17).

4. Tool for semiautomatic application and removal of multiple temporary fasteners, according to claim 1, wherein trigger action (10) of the pneumatic mechanism and advance trigger (28) of the feeding clip (3) give origin to the semiautomatic tool.

5. Tool for semiautomatic application and removal of multiple temporary fasteners, according to claim 1, wherein the placement of collection container (8) at the reaction base (7) holds the temporary fasteners (2) removed by the pin retraction movement (5) by releasing the trigger (10) and the return of the advance (6) cylinder.
